(19) United States
(12) Patent Application Publication
(10) Pub. No.: US 2011/0100789 A1
(43) Pub. Date: May 5, 2011

(54) THIN FILM SWITCH WITH CHANGEABLE OUTLET JOINT

(75) Inventor: Feng-Ting Hsu, Taipei County (TW)

(73) Assignee: JENSIN INTL TECHNOLOGY CORP., Taipei County (TW)

(21) Appl. No.: 12/985,355

(22) Filed: Jan. 6, 2011

Related U.S. Application Data
(63) Continuation-in-part of application No. 11/735,873, filed on Apr. 16, 2007, now abandoned.

(30) Foreign Application Priority Data
Apr. 17, 2006 (TW) 95113603

(51) Int. Cl. H01H 9/00

(52) U.S. Cl. 200/292

(57) ABSTRACT

A thin film switch with a changeable outlet joint includes two thin films, a touch circuit, and a soft flat cable. The two thin films have two opposite inner surfaces. The touch circuit includes a plurality of touch portions and an outlet end, which are disposed on the two opposite inner surfaces of the two thin films. Each couple of the touch portions switches to a conducting state when receiving a press action and transfers a signal to the outlet end. The outlet end has two first connecting pads. The first connecting pads are connected via a first connecting line. The first connecting pads and the first connecting line are disposed on the same one of the two opposite inner surfaces. The soft flat cable includes a connecting portion. The soft flat cable is connectably disposed on the outlet end through the connecting portion to form an outlet joint.

### CROSS-REFERENCE TO RELATED APPLICATION

This is a continuation-in-part application of patent application Ser. No. 11/735,873, filed on Apr. 16, 2007, which claims the priority benefit of Taiwan patent application serial no. 95113603, filed Apr. 17, 2006. The entirety of each of the above-mentioned patent applications is hereby incorporated by reference herein and made a part of this specification.

### BACKGROUND OF THE INVENTION

1. Field of the Invention

The present invention relates to a thin film switch. More particularly, the present invention relates to a thin film switch with a changeable outlet joint.

2. Description of Related Art

A thin film switch has a plurality of touch portions disposed on the inner surfaces of two opposite thin films respectively, and each couple of opposite touch potions touches each other under an external compression to conduct a circuit, thereby achieving a desired switch function to generate a signal. After being connected with circuits, several sets of thin film switches are able to be combined into a set of input device as a printed circuit board (PCB) of a notebook PC keyboard.

FIG. 1A is a schematic view of a conventional thin film switch with an outlet joint applied in a notebook PC keyboard. Generally speaking, a conventional thin film switch 10a with an outlet joint as shown in FIG. 1A in design and fabrication usually comprises a set of outlet joints 30a for connecting other hardware such as a motherboard, in addition to a thin film switch body 20a. However, since various customized products and the design thereof by different manufacturers are different in terms of the position and number of keys or touch portions 22a, the specification of thin film body 20a, the position of outlet end 24a, and the direction, length, and position of the outlet joint 30a, as for suppliers of thin film switch 10a, the flexibility of the production line and production scheduling is limited.

For example, in a thin film switch body 20b of another conventional thin film switch 10b with an outlet joint as shown in FIG. 1B, the position and number of touch portions 22b, the specification of the thin film switch body 20b, and the position of an outlet end 24b are all the same as those of the thin film switch body 20a as shown in FIG. 1A. However, the direction, length, and position of an outlet joint 30b are different from those of the outlet joint 30a of the conventional thin film switch 10a with an outlet joint as shown in FIG. 1A, so the two thin film switches cannot be scheduled into the same production line. In another conventional thin film switch 10c with an outlet joint as shown in FIG. 1C, the position and number of touch portions 22c, the specification of a thin film switch body 20c, and the position of an outlet joint 30c are the same as those of the conventional thin film switch 10a with an outlet joint as shown in FIG. 1A. However, the position of an outlet end 24c is different from that of the outlet end 24a of the conventional thin film switch 10a with an outlet joint as shown in FIG. 1A, so the two thin film switches cannot be scheduled into the same production line. In addition, since the specifications of the thin film switches designed by various manufacturers are different, diversified thin film switch products are provided by thin film switch suppliers, and thus the inventory control of the suppliers becomes more complex.

FIG. 2 is an expanded view of the conventional thin film switch 10a with an outlet joint of FIG. 1A before stack and alignment. As shown in FIG. 2, the conventional thin film switch 10a with an outlet joint tends to be limited by geometric shapes thereof, so that the required size of a thin film sheet 50 for manufacturing is larger. Furthermore, too much thin film waste 60 in blank may be generated, thereby causing the waste of the thin film sheet 50 material.

Typically, the conventional thin film switch comprises two circuit layers printed on two surfaces of two thin films, and the two circuit layers is separated by an insulating layer. The two circuit layers comprise a plurality of traces respectively. The traces are connected to a plurality of connecting pads arranged at the outlet joint. However, in order to connect each trace to the specific connecting pad, another insulating layer and another circuit layer comprising jumpers are necessary while a layout of the traces is complex. The cost of the thin film switch with jumpers becomes more expensive, and the manufacture of the thin film switch with jumpers becomes more complex.

### SUMMARY OF THE INVENTION

Accordingly, the present invention is directed to a thin film switch with a changeable outlet joint, so as to enhance the flexibility of a production line, reduce the complexity in the inventory control, and reduce the wastage of thin film material.

The thin film switch comprises two thin films, a touch circuit, and a soft flat cable. The two thin films have two opposite inner surfaces. The touch circuit comprises a plurality of touch portions and an outlet end, which are disposed on the two opposite inner surfaces of the two thin films. Each couple of the touch portions switches to a conducting state when receiving a press action and transfers a signal to the outlet end. The outlet end has two first connecting pads. The first connecting pads are connected via a first connecting line. The first connecting pads and the first connecting line are disposed on the same one of the two opposite inner surfaces. The soft flat cable comprises a connecting portion, and is connectably disposed on the outlet end through the connecting portion to form an outlet joint.

In an embodiment of the present invention, the connecting portion has a plurality of second connecting pads and a plurality of traces. Each of the plurality of traces connects one of the plurality of second connecting pads. One of the plurality of second connecting pads for connecting one of the two first connecting pads is separated from the plurality of traces.

In an embodiment of the present invention, the outlet end further has two second connecting pads. The two second connecting pads are connected via a second connecting line. The two second connecting pads and the second connecting line are disposed on the same one of the two opposite inner surfaces. The first connecting line and the second connecting line are disposed on the two opposite inner surfaces respectively.

In an embodiment of the present invention, the soft flat cable comprises an insulating substrate, a first circuit layer and a second circuit layer. The first circuit layer and the second circuit layer are disposed on two opposite surfaces of the insulating substrate respectively. The first circuit layer comprises a plurality of third connecting pads, and the second circuit layer comprises a plurality of fourth connecting pads.

In an embodiment of the present invention, the first circuit layer further comprises a plurality of fifth connecting pads, a plurality of first traces and a plurality of second traces. The second circuit layer further comprises a plurality of sixth connecting pads, a plurality of third traces and a third connecting line. The insulating substrate has a plurality of holes. The plurality of fifth connecting pads connect the plurality of sixth connecting pads via the plurality of holes. The plurality of fifth connecting pads connect the plurality of third connecting pads via the plurality of first traces. The plurality of fifth connecting pads connect the second traces. The plurality of sixth connecting pads connect the plurality of fourth connecting pads via the plurality of third traces. Two of the plurality of sixth connecting pads are connected via the third connecting line.

Another thin film switch comprises two thin films, a touch circuit, and a soft flat cable. The two thin films have two opposite inner surfaces. The touch circuit comprises a plurality of touch portions and an outlet end, which are disposed on the two opposite inner surfaces of the two thin films. Each couple of the touch portions switches to a conducting state when receiving a press action and transfers a signal to the outlet end. The soft flat cable comprises a connecting portion, and is connectably disposed on the outlet end through the connecting portion to form an outlet joint. The connecting portion has two first connecting pads, the two first connecting pads are connected via a first connecting line.

In an embodiment of the present invention, the soft flat cable comprises an insulating substrate and a circuit layer, the circuit layer is disposed on the insulating substrate The circuit layer comprises a plurality of traces, a plurality of second connecting pads, the two first connecting pads and the first connecting line Each of the plurality of traces connects one of the plurality of second connecting pads or one of the two first connecting pads Another one of the two first connecting pads is separated from the plurality of traces.

Another thin film switch comprises two thin films, a touch circuit, and a soft flat cable. The two thin films have two opposite inner surfaces. The touch circuit comprises a plurality of touch portions and an outlet end, which are disposed on the two opposite inner surfaces of the two thin films. Each couple of the touch portions switches to a conducting state when receiving a press action and transfers a signal to the outlet end. The soft flat cable comprises a connecting portion, and is connectably disposed on the outlet end through the connecting portion to form an outlet joint. The soft flat cable comprises an insulating substrate, a first circuit layer and a second circuit layer The first circuit layer and the second circuit layer are disposed on two opposite surfaces of the insulating substrate respectively. The first circuit layer comprises a plurality of first connecting pads, a second connecting pad, a plurality of first traces, a second trace and a third trace The second circuit layer comprises a connecting line, each of the first traces connects one of the plurality of first connecting pads The second trace connects the second connecting pad. The plurality of first connecting pads and the second connecting pad constitute the connecting portion. The insulating substrate has a plurality of holes. The connecting line connect the second trace and the third trace via the plurality of holes. In the present invention, the soft flat cable and the thin film switch are separately designed and manufactured, and are not limited to the conventional design, thereby greatly improving the flexibility of the production line and the stock, effectively reducing the wastage of thin film material, and enhancing the substitution of products.

In order to the make aforementioned and other objects, features and advantages of the present invention comprehensible, preferred embodiments accompanied with figures are described in detail below.

### BRIEF DESCRIPTION OF THE DRAWINGS

FIG. 1A is a schematic view of a conventional thin film switch with an outlet joint.

FIG. 1B is a schematic view of another conventional thin film switch with an outlet joint.

FIG. 1C is a schematic view of still another conventional thin film switch with an outlet joint.

FIG. 2 is a view of the conventional thin film switch with an outlet joint as shown in FIG. 1A before folding and alignment.

FIG. 3A is a combination view of a thin film switch with a changeable outlet joint according to an embodiment of the present invention.

FIG. 3B is an exploded view of a thin film switch body and a soft flat cable of FIG. 3A.

FIG. 3C is a schematic view of a soft flat cable according to another embodiment of the present invention.

FIG. 4 is a sectional view of the touch unit of FIG. 3A.

FIG. 5 is a schematic view of the size of a thin film sheet used for the thin film switch of FIG. 3B in simulated production.

FIG. 6A is a schematic view of the size of a thin film used for the soft flat cable in FIG. 3B in simulated production.

FIG. 6B is a schematic view of another combination of FIG. 6A.

FIG. 7 is an isometric view of a notebook PC keyboard with a changeable outlet joint according to an embodiment of the present invention.

FIG. 8 is a thin film switch with a changeable outlet joint according to an embodiment of the present invention.

FIG. 9 is a thin film switch with a changeable outlet joint according to an embodiment of the present invention.

FIGS. 10A and 10B show four circuit layers of a thin film switch with a changeable outlet joint according to an embodiment of the present invention, respectively.

FIG. 11 is a thin film switch with a changeable outlet joint according to an embodiment of the present invention.

FIG. 12 is a thin film switch with a changeable outlet joint according to an embodiment of the present invention.

### DESCRIPTION OF EMBODIMENTS

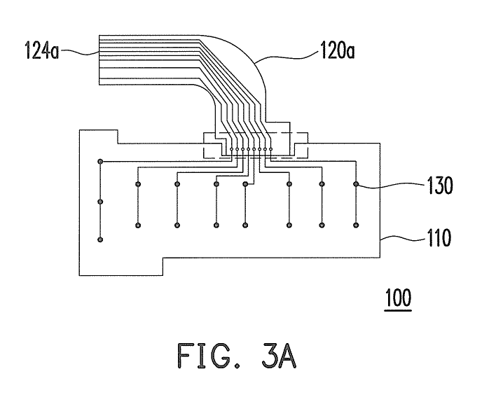

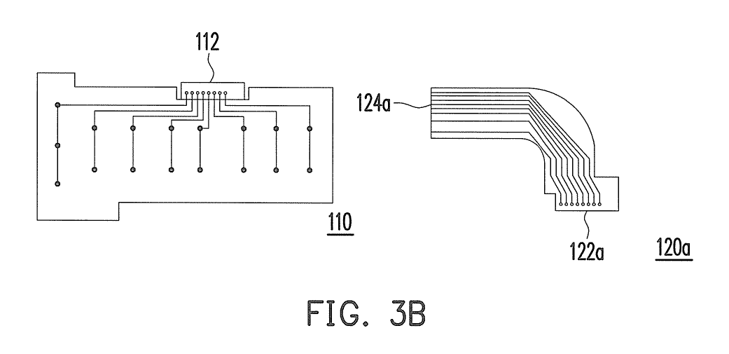

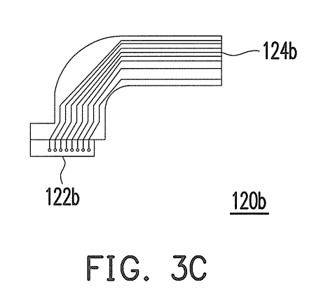

FIG. 3A is a view of the thin film switch 100 with a changeable outlet joint according to an embodiment of the present invention. The thin film switch 100 with a changeable outlet joint includes a thin film switch body 110 and a soft flat cable 120a, wherein the thin film switch body 110 includes a plurality of touch units 130. FIG. 3B is an exploded view of the thin film switch body 110 and the soft flat cable 120a of FIG. 3A. Referring to FIG. 3B, after the soft flat cable 120a is connectably disposed on an outlet end 112 of the thin film switch body 110 through a connecting portion 122a, the end 124a of the soft flat cable 120a as shown in FIG. 3A is formed. The soft flat cable 120a can be a conventional thin film flat cable or a flexible printed circuit board. In the present invention, the material of the soft flat cable 120a is the same as that of the thin film switch and may be also be fabricated by the same process. The connecting portion 122a may be a binding material including a self adhesive tape, a hot press adhesive, an anisotropic conductive paste, and the like.

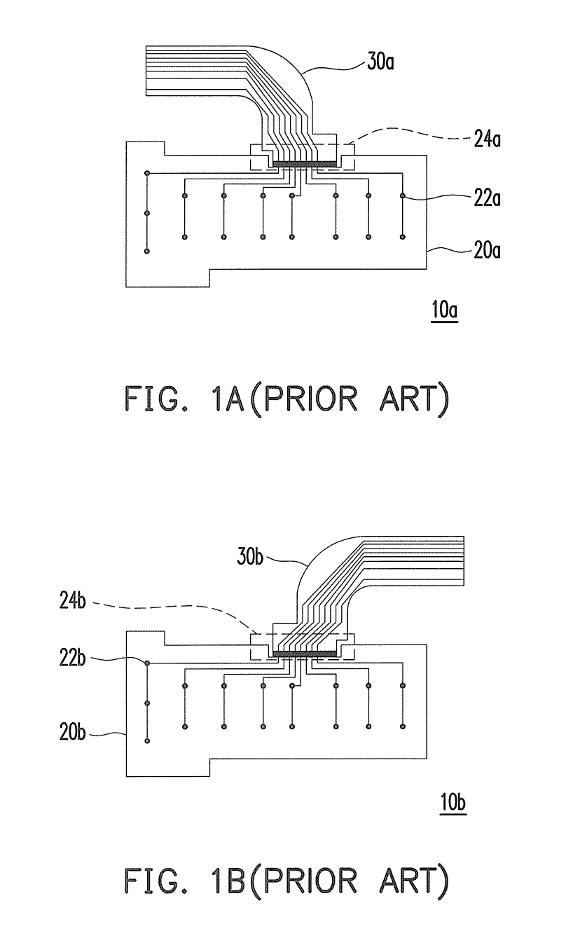

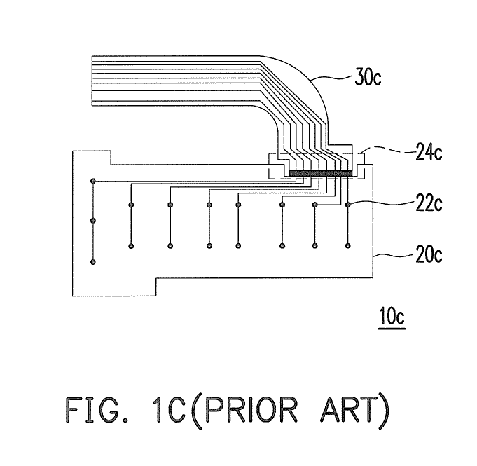

FIG. 3C is a schematic view of a soft flat cable 120b according to another embodiment of the present invention. A connecting portion 122b is the same as the connecting portion 122a of FIG. 3B except for the extending direction and position of an end 124b are different from those of the end 124a of FIG. 3B. Compared to the conventional film switches 10a and 10b, as shown in FIGS. 1A and 1B, which require two separate production line for fabrication thereof due to the different extending directions and positions of the outlet joints 30a and 30b, the present invention employs the same thin film switch body 110 with different soft flat cables 120a and 120b to form the two conventional thin film switches 10a and 10b (FIGS. 1A and 1B), as shown in FIGS. 3B and 3C. Furthermore, as shown in FIGS. 1A and 1C, when the position of the outlet ends 24a and 24c of the thin film switches 10a and 10c are different, and the number and position of the touch portions 22a and 22c and the composition of the outlet ends 24a and 24c are the same, the thin film switch 20c of FIG. 1C may be modified to be fabricated together with the thin film switch body 110 through the same production line, and then is used with another soft flat cable. Therefore, the present invention may effectively improve the flexibility of the production line and the substitution of thin film switches, and thereby effectively reduce the inventory of suppliers, and reduce the complexity in inventory control.

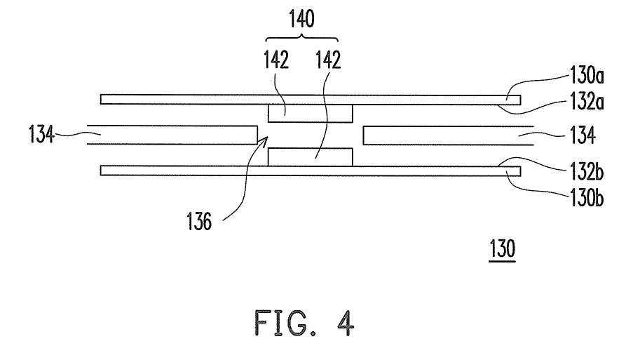

FIG. 4 is a sectional view of a touch unit 130 of the thin film switch body 110 in FIG. 3A. As shown in FIG. 4, the touch unit 130 includes two thin films 130a, 130b and a touch circuit 140. The two thin films 130a and 130b include two opposite inner surfaces 132a and 132b. The touch circuit 140 includes a plurality of touch portions 142, which are disposed on the two opposite inner surfaces 132a and 132b of the thin films 130a and 130b. Each couple of the touch portions 142 switches to a conducting state when receiving a press action, and transfers a signal to the outlet end 112 of FIG. 3B. The touch unit 130 further includes an insulating layer 134 disposed between the thin films 130a and 130b. The insulating layer 134 has a plurality of holes 136 corresponding to each couple of the touch potions 142 respectively.

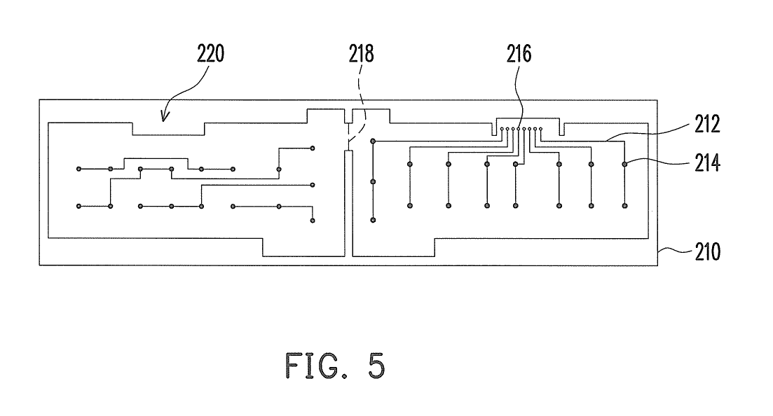

The thin film switch of the present invention may be fabricated in the same manner as that of the conventional thin film switch or the flexible printed circuit board. As shown in FIG. 5, a metal layer and a photoresist layer (not shown) is formed on a surface of a thin film 210, and the photoresist layer is exposed and developed to form a predetermined circuit pattern. Next, the metal layer is etched to form a desired circuit 212, touch portions 214, and an outlet end 216. Thin film waste 220 is cutoff according to a desired profile of the thin film 210, and then the thin film 210 is folded in half along a fold line 218. After that, an insulating layer is added and then laminated, so as to form the thin film switch 110 of FIG. 3B.

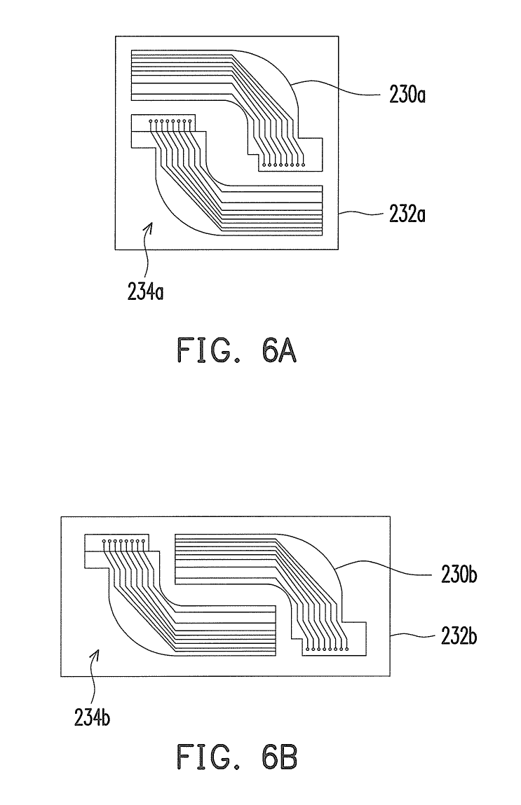

As shown in FIG. 6A, the soft flat cables 230a of the present invention can be arranged in pairs on the same thin film sheet 232a according to the geometric shape thereof and then processed simultaneously. The process of manufacturing the soft flat cables 230a is the same as that of the conventional thin film switch or the flexible printed circuit board, and the details will not be described herein again. Next, the thin film waste 234a is cutoff according to a desired profile. FIG. 6B is another embodiment of FIG. 6A. In this embodiment, soft flat cables 230b are arranged on a thin film sheet 232b in a different manner, and then thin film waste 234b is cutoff to form the two sets of soft flat cables 230b.

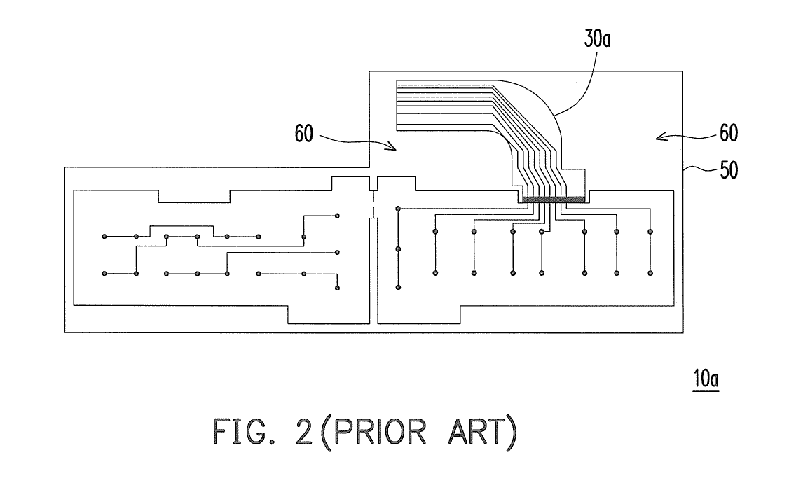

Comparing the thin film wastes 220, 234a, and 234b of FIGS. 5, 6A, and 6B with the thin film waste 60 of the conventional thin film switch 10a of FIG. 2, the conventional thin film switch 10a with an outlet joint generates comparatively more thin film waste 60 after being processed due to the limitation of the geometric shapes of the thin film switch body and the soft flat cables. In the present invention, since the thin film switch body and the soft flat cables are separately manufactured, the thin film material is effectively utilized and the thin film waste resulting from the processing is reduced.

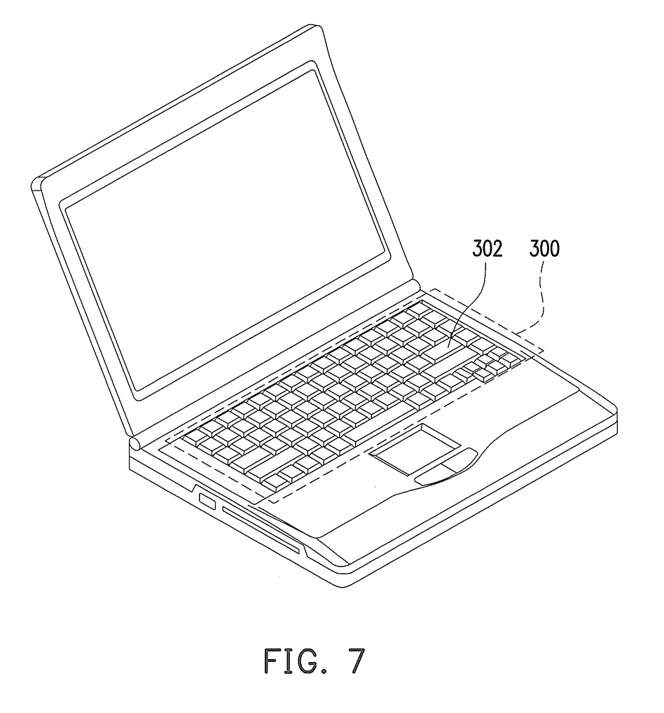

FIG. 7 is an isometric view of a notebook PC keyboard 300 with a changeable outlet joint according to an embodiment of the present invention. The schematic partial enlarged view of a thin film switch (not shown) at the bottom of the keyboard and the reference numbers can refer to FIG. 3A of an embodiment of the present invention. The keyboard 300 with a changeable outlet joint comprises a plurality of keys 302, a thin film switch 110, and a soft flat cable 120a. The composition of the thin film switch 110 and the soft flat cable 120a are the same as those in the preceding embodiment and the details will not be described herein again. The thin film switch 110 of FIG. 3A is mounted below the keys of FIG. 7, and each of the keys 302 must be aligned with the corresponding touch units 130 of FIG. 3A. Meanwhile, the end 124a of the soft flat cable 120a of FIG. 3A must be connected to a motherboard slot (not shown) of a notebook PC in FIG. 7. By pressing each of the keys 302, the corresponding touch unit 130 in FIG. 3A can generate and transmit a signal to the motherboard through the soft flat cable 120a, thereby achieving the desired data input function.

In view of the above, in the present invention, since the thin film switch and the soft flat cable are designed to be manufactured separately, it is unnecessary to manufacture the thin film switches with the same function and size through different production lines simply because of the outlet joints with different length or positions. Meanwhile, the thin film switches with the same function and size, which are originally designed to be manufactured separately due to the outlet joints with different positions, may be modified to have the same specification. Therefore, the present invention not only improves the flexibility of the production line and production scheduling, but also improves the substitution of the thin film switch. Meanwhile, the inevitable blank between the thin film switch and the soft flat cable in the conventional design can be eliminated because the thin film switch and the soft flat cable are manufactured separately, thereby reducing the waste of thin film material. Moreover, the complexity of the inventory control of the thin film switch suppliers caused by the diversification of products can also be effectively reduced.

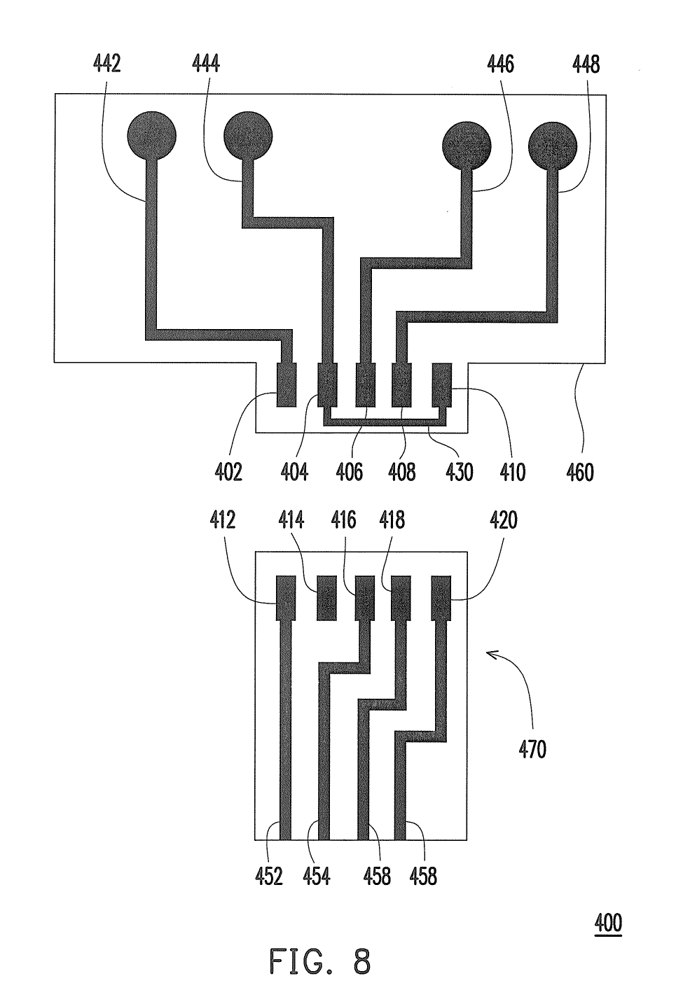

FIG. 8 is a thin film switch with a changeable outlet joint according to an embodiment of the present invention. The thin film switch 400 of FIG. 8 is similar to the thin film switch 200 of FIG. 3A, and only the differences between the thin film switches 400 and 200 are described hereafter. The outlet end has connecting pads 402, 404, 406, 408 and 410, a connecting line 430 and traces 442, 444, 446 and 448. The connecting pads 402, 404, 406, 408 and 410, the connecting line 430 and the traces 442, 444, 446 and 448 are formed from the same printed circuit layer. The connecting pads 404 and 410 are connected via the connecting line 430. The connecting pad 402 is connected to the trace 442. The connecting pad 404 is connected to the trace 444. The connecting pad 406 is connected to the trace 446. The connecting pad 408 is connected to the trace 448. The thin film switch 400 has only two printed circuit layers on two thin films respectively, and only part of one thin film 460 and part of one printed circuit layer including the connecting line 430 are shown in FIG. 8.

The connecting portion 470 comprises connecting pads 412, 414, 416, 418 and 420 and traces 452, 454, 456 and 458. The connecting pad 412 is connected to the trace 452. The connecting pad 414 is isolated. The connecting pad 416 is connected to the trace 454. The connecting pad 418 is connected to the trace 456. The connecting pad 420 is connected to the trace 458. The connecting pads 402, 404, 406, 408 and 410 are used to connect the connecting pads 412, 414, 416, 418 and 420, respectively. Therefore, a signal from the trace 442 can be transmitted to the trace 452, a signal from the trace 444 can be transmitted to the trace 458, a signal from the trace 446 can be transmitted to the trace 454, and a signal from the trace 448 can be transmitted to the trace 456. That is, by the connecting line 430, the signals from the traces 452, 454, 456 and 458 can be transmitted to the traces 452, 454, 456 and 458 in a specific rule. Jumpers formed from a printed circuit layer other than said two printed circuit layers on two thin films are not necessary. The cost of the thin film switch 400 is cheap, and the manufacture of the thin film switch 400 is simple. If necessary, more than one connecting line can be applied to the thin film switch 400.

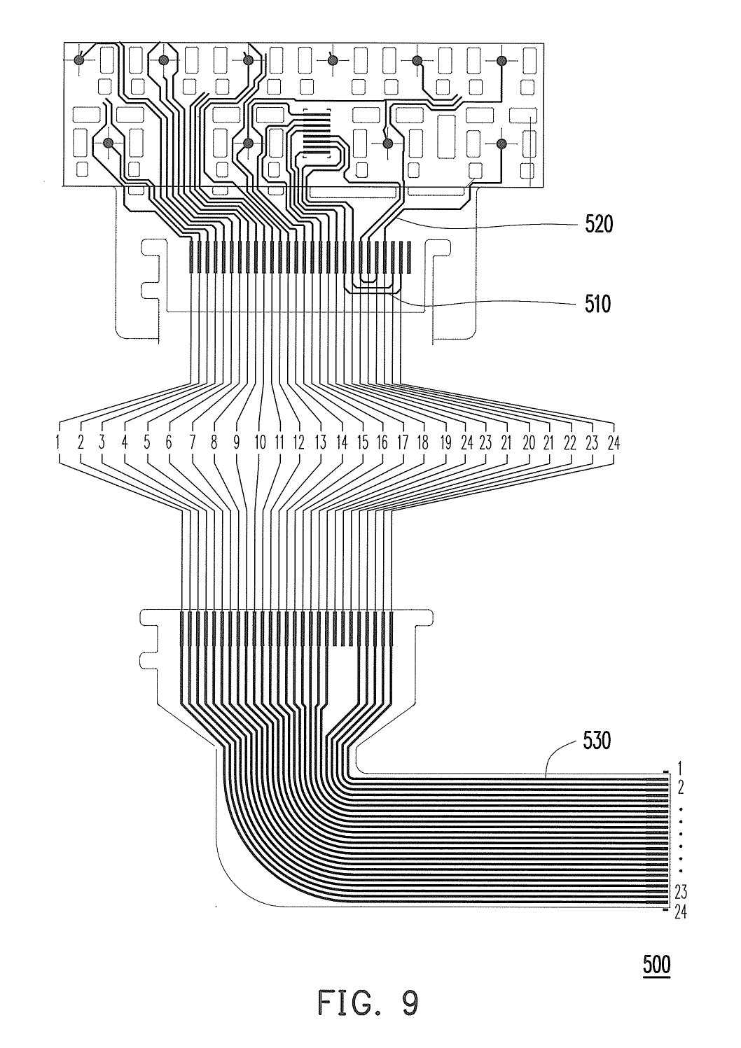

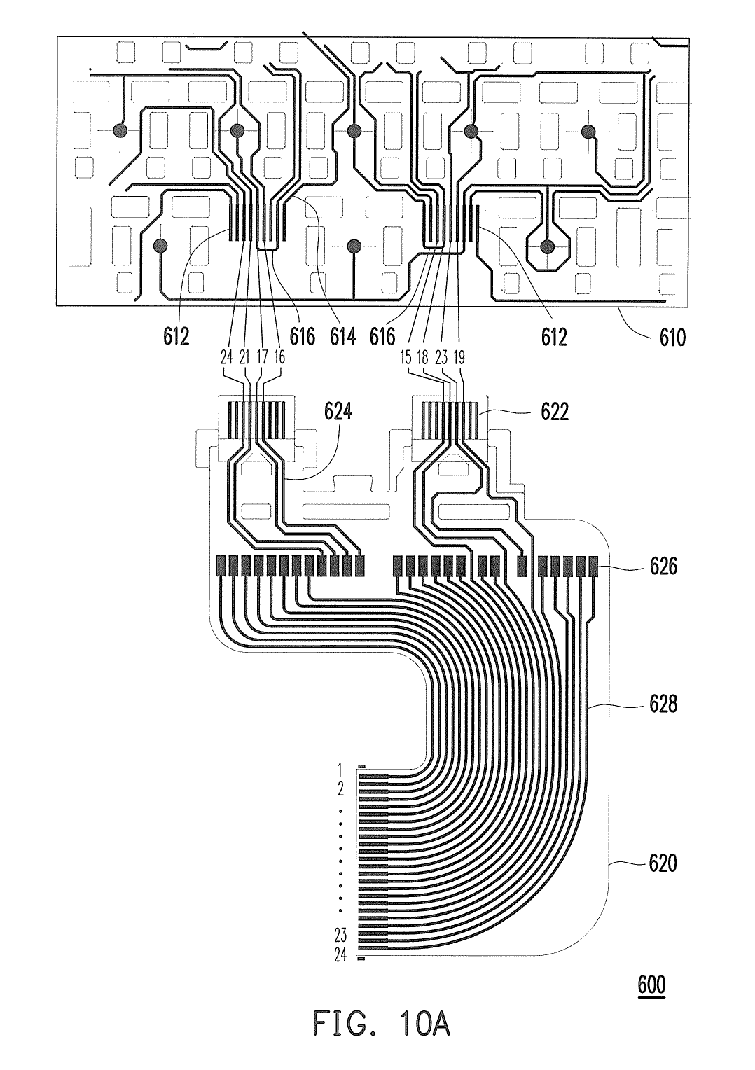

FIG. 9 is a thin film switch with a changeable outlet joint according to an embodiment of the present invention. The thin film switch 500 of FIG. 9 is similar to the thin film switch 400 of FIG. 8. By three connecting lines 510, the signals presented sequentially with numbers “1, 2, . . . , 19, 24, 23, 21, 20, 21, 22, 23, 24” from the traces 520 can be transmitted to the traces 530 with rearranged sequence “1, 2, . . . , 24”. Only two printed circuit layers on two thin films are necessary for the thin film switch 500.

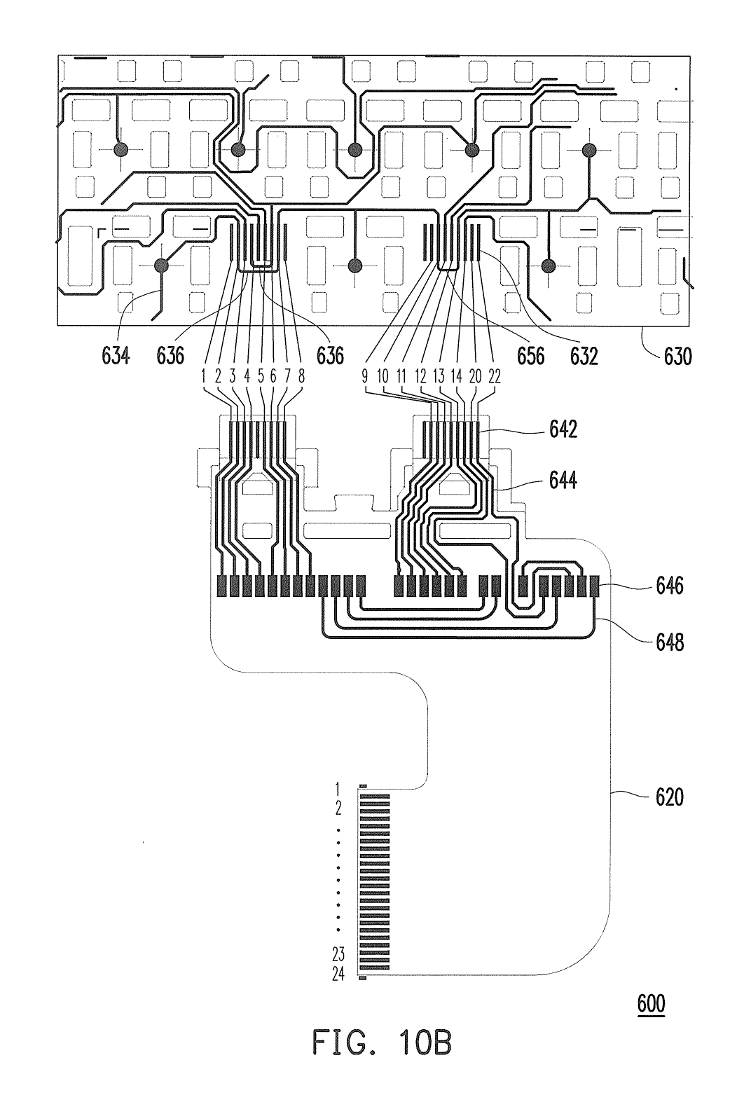

FIGS. 10A and 10B show four circuit layers of a thin film switch with a changeable outlet joint according to an embodiment of the present invention, respectively. A circuit layer formed on a bottom surface of a top thin film 610 of the thin film switch 600 comprises eighteen connecting pads 612, traces 614 and two connecting lines 616. A circuit layer formed on a top surface of an insulating substrate 620 of a soft flat cable of the thin film switch 600 comprises eighteen connecting pads 622, five traces 624, twenty six connecting pads 626 and twenty four traces 628. The traces 614 are connected to the connecting pads 612. Each connecting line 616 connects two connecting pads 612. The connecting pads 612 are used to connect the connecting pads 622. Parts of the connecting pads 622 are connected to the connecting pads 626 through the traces 624. The traces 628 are connected to the connecting pads 626.

A circuit layer formed on a top surface of a bottom thin film 630 of the thin film switch 600 comprises eighteen connecting pads 632, traces 634 and three connecting lines 636. A circuit layer formed on a bottom surface of the insulating substrate 620 of the soft flat cable of the thin film switch 600 comprises eighteen connecting pads 642, sixteen traces 644, twenty six connecting pads 646 and four connecting lines 648. The traces 634 are connected to the connecting pads 632. Each connecting line 636 connects two connecting pads 632. The connecting pads 632 are used to connect the connecting pads 642. Parts of the connecting pads 642 are connected to the connecting pads 646 through the traces 644. Each connecting line 648 connects two connecting pads 646. The insulating substrate 620 has twenty six holes covered by the connecting pads 626 and 646, such that the connecting pads 626 connect the connecting pads 646 via the holes of the insulating substrate 620.

In the thin film switch 600, the signals presented sequentially with numbers “24, 21, 17, 16, 15, 18, 23, 29” from the traces 614 in FIG. 10A and the signals presented sequentially with numbers “1, 2, 3, 4, 5, 6, 7, 8, 9, 10, 11, 12, 13, 14, 20, 22” from the traces 634 in FIG. 10B can be transmitted to the traces 628 with rearranged sequence “1, 2, . . . , 24”. Only two printed circuit layers on two thin films 610 and 630 are necessary for the thin film switch 600.

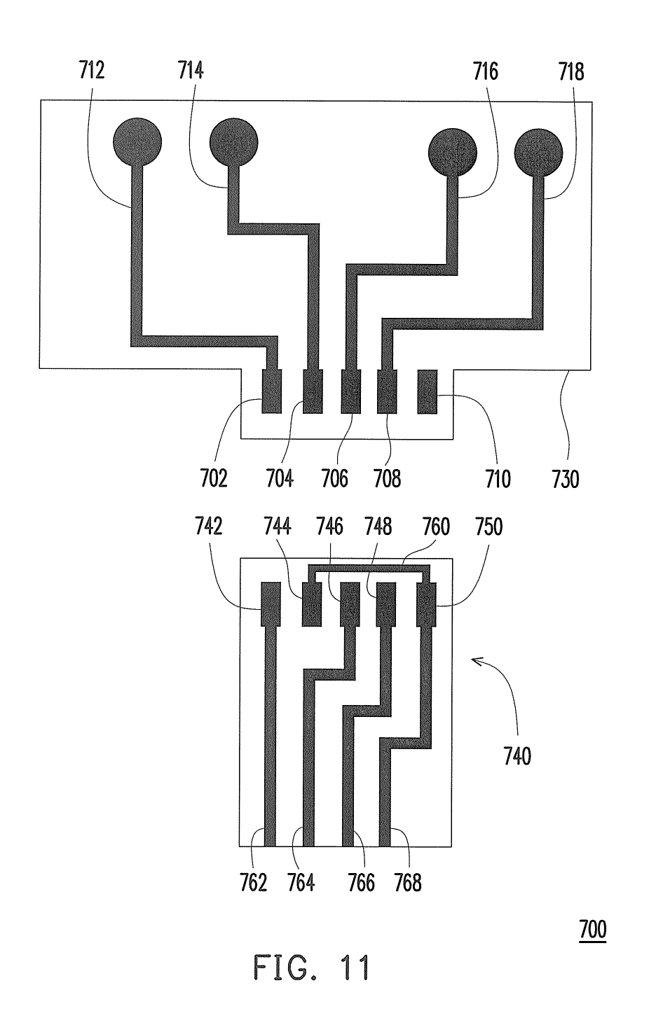

FIG. 11 is a thin film switch with a changeable outlet joint according to an embodiment of the present invention. The thin film switch 700 of FIG. 11 is similar to the thin film switch 200 of FIG. 3A, and only the differences between the thin film switches 700 and 200 are described hereafter. The outlet end has connecting pads 702, 704, 706, 708 and 710 and traces 712, 714, 716 and 718. The connecting pads 702, 704, 706, 708 and 710 and the traces 712, 714, 716 and 718 are formed from the same printed circuit layer. The connecting pad 702 is connected to the trace 712. The connecting pad 704 is connected to the trace 714. The connecting pad 706 is connected to the trace 716. The connecting pad 708 is connected to the trace 718. The connecting pad 710 is isolated. The thin film switch 700 has only two printed circuit layers on two thin films respectively, and only part of one thin film 730 and part of one printed circuit layer including the connecting pad 710 are shown in FIG. 11. The connecting portion 740 comprises connecting pads 742, 744, 746, 746 and 750, a connecting line 760 and traces 762, 764, 766 and 768. The connecting pad 742 is connected to the trace 762. The connecting pads 744 and 750 are connected via the connecting line 760. The connecting pad 746 is connected to the trace 764. The connecting pad 748 is connected to the trace 766. The connecting pad 750 is connected to the trace 768. The connecting pads 702, 704, 706, 708 and 710 are used to connect the connecting pads 742, 744, 746, 746 and 750, respectively.

Therefore, a signal from the trace 712 can be transmitted to the trace 762, a signal from the trace 714 can be transmitted to the trace 768, a signal from the trace 716 can be transmitted to the trace 764, and a signal from the trace 718 can be transmitted to the trace 766. That is, by the connecting line 760, the signals from the traces 712, 714, 716 and 718 can be transmitted to the traces 762, 764, 766 and 768 in a specific rule. Jumpers formed from a printed circuit layer other than said two printed circuit layers on two thin films are not necessary. The cost of the thin film switch 700 is cheap, and the manufacture of the thin film switch 700 is simple. If necessary, more than one connecting line can be applied to the thin film switch 700.

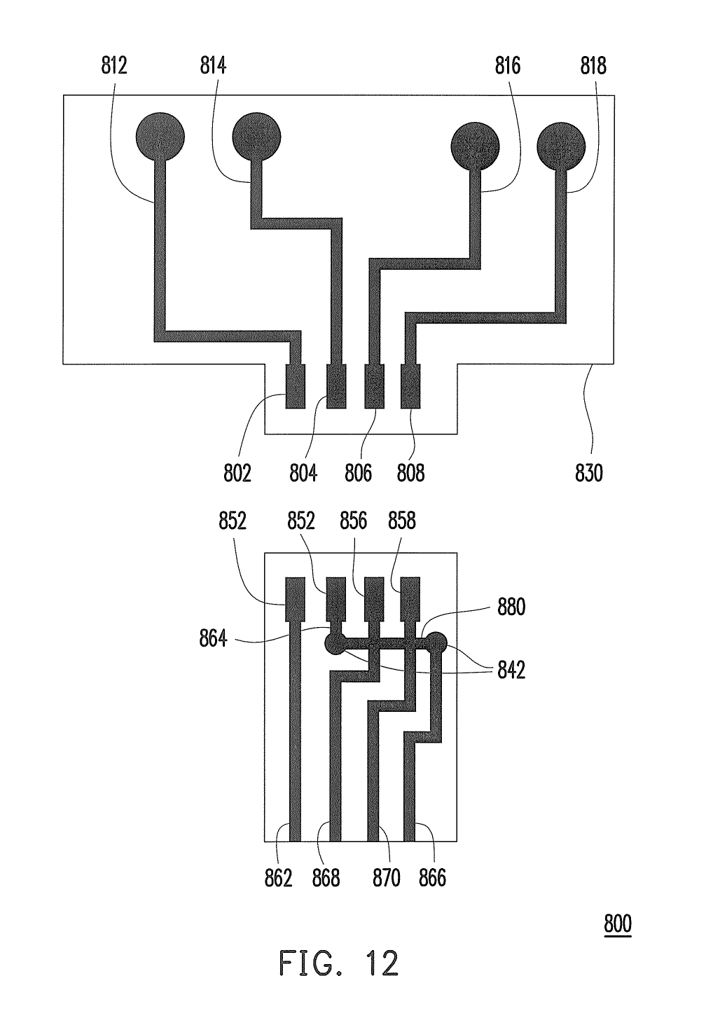

FIG. 12 is a thin film switch with a changeable outlet joint according to an embodiment of the present invention. The thin film switch 800 of FIG. 12 is similar to the thin film switch 200 of FIG. 3A, and only the differences between the thin film switches 800 and 200 are described hereafter. The outlet end has connecting pads 802, 804, 806 and 808 and traces 812, 814, 816 and 818. The connecting pads 802, 804, 806 and 808 and the traces 812, 814, 816 and 818 are formed from the same printed circuit layer. The connecting pad 802 is connected to the trace 812. The connecting pad 804 is connected to the trace 814. The connecting pad 806 is connected to the trace 816. The connecting pad 808 is connected to the trace 818. The thin film switch 800 has only two printed circuit layers on two thin films respectively, and only part of one thin film 830 and part of one printed circuit layer including the connecting pad 802 are shown in FIG. 12.

A circuit layer formed on a top surface of an insulating substrate 840 of a soft flat cable of the thin film switch 800 comprises connecting pads 852, 854, 856 and 858 and traces 862, 864, 866, 868, 870. A circuit layer formed on a bottom surface of the insulating substrate 840 of the soft flat cable of the thin film switch 800 comprises a connecting line 880. The connecting pads 802, 804, 806 and 808 are used to connect the connecting pads 852, 854, 856 and 858, respectively. The traces 862 are connected to the connecting pads 852. The connecting pad 854 is connected to the trace 864. The connecting pad 856 is connected to the trace 868. The connecting pad 858 is connected to the trace 870. The insulating substrate 840 has two holes 842, such that the connecting line 880 connects the trace 864 and 866 via the holes 842 of the insulating substrate 840.

Therefore, a signal from the trace 812 can be transmitted to the trace 862, a signal from the trace 814 can be transmitted to the trace 866, a signal from the trace 816 can be transmitted to the trace 868, and a signal from the trace 818 can be transmitted to the trace 870. That is, by the connecting line 880 and the holes 842, the signals from the traces 812, 814, 816 and 818 can be transmitted to the traces 862, 866, 868 and 870 in a specific rule. Jumpers formed from a printed circuit layer other than said two printed circuit layers on two thin films are not necessary. The cost of the thin film switch 800 is cheap, and the manufacture of the thin film switch 800 is simple. If necessary, more than one connecting line can be applied to the thin film switch 800.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thin film switches with a changeable outlet joint, comprising:
two thin films, having two opposite inner surfaces;
a touch circuit, having a plurality of touch portions and an outlet end, which are disposed on the two opposite inner surfaces of the two thin films, wherein each couple of the touch portions switches to a conducting state in response to receiving a press action and transfers a signal to the outlet end, the outlet end has two first connecting pads, the two first connecting pads are connected via a first connecting line, the two first connecting pads and the first connecting line are disposed on the same one of the two opposite inner surfaces; and
a soft flat cable, having a connecting portion, connectably disposed on the outlet end through the connecting portion to form an outlet joint.

2. The thin film switch with a changeable outlet joint as claimed in claim 1, wherein the connecting portion has a plurality of second connecting pads and a plurality of traces, each of the plurality of traces connects one of the plurality of second connecting pads, and one of the plurality of second connecting pads for connecting one of the two first connecting pads is separated from the plurality of traces.

3. The thin film switch with a changeable outlet joint as claimed in claim 1, wherein the outlet end further has two second connecting pads, the two second connecting pads are connected via a second connecting line, the two second connecting pads and the second connecting line are disposed on the same one of the two opposite inner surfaces, and the first connecting line and the second connecting line are disposed on the two opposite inner surfaces respectively.

4. The thin film switch with a changeable outlet joint as claimed in claim 3, wherein the soft flat cable comprises an insulating substrate, a first circuit layer and a second circuit layer, the first circuit layer and the second circuit layer are disposed on two opposite surfaces of the insulating substrate respectively, the first circuit layer comprises a plurality of third connecting pads, and the second circuit layer comprises a plurality of fourth connecting pads.

5. The thin film switch with a changeable outlet joint as claimed in claim 4, wherein the first circuit layer further comprises a plurality of fifth connecting pads, a plurality of first traces and a plurality of second traces, the second circuit layer further comprises a plurality of sixth connecting pads, a plurality of third traces and a third connecting line, the insulating substrate has a plurality of holes, the plurality of fifth connecting pads connect the plurality of sixth connecting pads via the plurality of holes, the plurality of fifth connecting pads connect the plurality of third connecting pads via the plurality of first traces, the plurality of fifth connecting pads connect the second traces, the plurality of sixth connecting pads connect the plurality of fourth connecting pads via the plurality of third traces, and two of the plurality of sixth connecting pads are connected via the third connecting line.

6. A thin film switches with a changeable outlet joint, comprising:
two thin films, having two opposite inner surfaces;
a touch circuit, having a plurality of touch portions and an outlet end, which are disposed on the two opposite inner surfaces of the two thin films, wherein each couple of the touch portions switches to a conducting state in response to receiving a press action and transfers a signal to the outlet end; and
a soft flat cable, having a connecting portion, connectably disposed on the outlet end through the connecting portion to form an outlet joint, wherein the connecting portion has two first connecting pads, the two first connecting pads are connected via a first connecting line.

7. The thin film switch with a changeable outlet joint as claimed in claim 6, wherein the soft flat cable comprises an insulating substrate and a circuit layer, the circuit layer is disposed on the insulating substrate, the circuit layer comprises a plurality of traces, a plurality of second connecting pads, the two first connecting pads and the first connecting line, each of the plurality of traces connects one of the plurality of second connecting pads or one of the two first connecting pads, and another one of the two first connecting pads is separated from the plurality of traces.

8. A thin film switches with a changeable outlet joint, comprising:
two thin films, having two opposite inner surfaces;
a touch circuit, having a plurality of touch portions and an outlet end, which are disposed on the two opposite inner surfaces of the two thin films, wherein each couple of the touch portions switches to a conducting state in response to receiving a press action and transfers a signal to the outlet end; and
a soft flat cable, having a connecting portion, connectably disposed on the outlet end through the connecting portion to form an outlet joint, wherein the soft flat cable comprises an insulating substrate, a first circuit layer and a second circuit layer, the first circuit layer and the second circuit layer are disposed on two opposite surfaces of the insulating substrate respectively, the first circuit layer comprises a plurality of first connecting pads, a second connecting pad, a plurality of first traces, a second trace and a third trace, the second circuit layer comprises a connecting line, each of the first traces connects one of the plurality of first connecting pads, the second trace connects the second connecting pad, the plurality of first connecting pads and the second connecting pad constitute the connecting portion, the insulating substrate has a plurality of holes, the connecting line connect the second trace and the third trace via the plurality of holes.
